(19) United States
(12) Patent Application Publication
(10) Pub. No.: US 2024/0182745 A1
(43) Pub. Date: Jun. 6, 2024

(54) COATINGS WITH IMPROVED STAIN REMOVAL

(71) Applicant: BASF SE, Ludwigshafen am Rhein (DE)

(72) Inventor: Kaliappa RAGUNATHAN, Charlotte, NC (US)

(21) Appl. No.: 18/285,663

(22) PCT Filed: Mar. 31, 2022
(86) PCT No.: PCT/US2022/022938

§ 371 Date: Oct. 5, 2023

Related U.S. Application Data
(60) Provisional application No. 63/171,318, filed on Apr. 6, 2021.

(51) Int. Cl. C09D 151/00; C08F 265/04; C09D 7/63

(52) U.S. Cl. CPC C09D 151/003; C08F 265/04; C09D 7/63

(57) ABSTRACT

Disclosed herein are coating compositions with enhanced stain removal properties including easy removal of hydrophobic and hydrophilic stains. In some embodiments, the coating comprises multistage polymers, as well as coating compositions containing multistage polymers for use in a variety of applications providing easy stain removal.

### FIELD OF THE INVENTION

The present disclosure relates generally to multistage polymers, as well as coating compositions containing multistage polymers for use in a variety of applications providing easy stain removal.

### BACKGROUND OF THE INVENTION

Paints and coatings based on emulsion polymers, generally referred to as “latex” paints or coatings, are well known and widely used in a variety of applications. In particular, latex paints have captured a significant portion of the indoor and outdoor paint market, primarily because of their significant advantages over organic solvent-based paints. For example, latex paints offer easier cleanup than solvent-based paints. Latex paints also provide for reduced levels of volatile organic solvents as compared to solvent-based paints.

In spite of their many advantages, stain removal from coated and painted wall surfaces is very challenging, especially removal of hydrophobic stains such as lipstick, graphite pencil, crayon, black oil stain, mustard, lenetta oil stain and hydrophilic stains such as coffee, vinegar, crayola marker, such as a crayola red marker, wine and the like. Often, either hydrophobic or hydrophilic stains are removable but not both.

Thus, there is a continuing need for aqueous polymer dispersions such as latex polymers which can provide coatings or films having excellent performance properties, including easy removal of both, hydrophobic and hydrophilic stains.

### SUMMARY OF THE DISCLOSURE

Provided herein are multistage polymers that comprise (i) a first stage comprising a first copolymer having a first theoretical glass-transition temperature (Tg), the first copolymer being derived from a soft ethylenically-unsaturated monomer, and a phosphorus-containing monomer, and optionally a acetoacetoxy or keto monomer and a polyfunctional amine; and (ii) a second stage comprising a second copolymer having a second theoretical Tg, the second copolymer being derived from one or more hard ethylenically-unsaturated monomers, an acid monomer, e.g., methacrylic acid, acrylic acid, itaconic acid, phosphorous acid monomers, or sulfonate monomers and optionally an acetoacetoxy or keto monomer and a polyfunctional amine.

The multistage polymers can be in the form of multilayer particles that comprise (i) a first layer comprising a first copolymer having a first theoretical Tg, the first copolymer being derived from a soft ethylenically-unsaturated monomer, and a phosphorus-containing monomer, and optionally an acetoacetoxy or keto monomer and a polyfunctional amine; and (ii) a second layer surrounding at least a portion of the first layer comprising a second copolymer having a second theoretical Tg, the second copolymer being derived from one or more hard ethylenically-unsaturated monomers and acid monomers, e.g., methacrylic acid, acrylic acid, itaconic acid, phosphorous acid monomers, or sulfur acid monomers, and optionally an acetoacetoxy or keto monomer and a polyfunctional amine.

The multistage polymers can be in the form of multilayer particles that comprise more than two layers, having an outermost layer comprising a copolymer being derived from one or more hard ethylenically-unsaturated monomers and acid monomers, e.g., methacrylic acid, acrylic acid, itaconic acid, phosphorous acid monomers, or sulfur acid monomers, and optionally an acetoacetoxy or keto monomer and a polyfunctional amine, which is referred to above as the second polymer.

The first copolymer can have a theoretical Tg of 35° C. or less (e.g., 20° C. or less). The second copolymer can have a theoretical Tg of at least 20° C. (e.g., of at least 40° C.). The second copolymer theoretical Tg can be at least 0° C. greater than the first copolymer theoretical Tg (e.g, at least 50° C. greater than the first copolymer theoretical Tg, or at least 75° C. greater than the first copolymer theoretical Tg).

The first copolymer can include an acrylic-based copolymer. In some embodiments, the first copolymer can be derived from (i) one or more soft (meth)acrylate monomers (e.g., from greater than 20% by weight of one or more (meth)acrylate monomers such as n-butylacrylate, ethyl acrylate, i-butyl acrylate, 2-ethylhexyl(meth)acrylate, and combinations thereof, based on the total weight of the monomers used to form the first copolymer); (ii) one or more phosphorus-containing monomers (e.g., from greater than 0% by weight to 10% by weight 2-phosphoethyl(meth)acrylate); (iii) optionally one or more acetoacetoxy or keto monomers (e.g., from greater than 0% by weight to 15% by weight acetoacetoxyethyl (meth)acrylate or diacetone acrylamide) and a polyfunctional amine; and (iv) optionally one or more additional ethylenically-unsaturated monomers, excluding monomers (i), (ii) or (iii).

The second copolymer can be derived from at least 30% by weight of one or more hard ethylenically-unsaturated monomers, based on the total weight of the monomers used to form the second copolymer, one or more acid-containing monomers that, when copolymerized, form a polymer having a Tg, as measured using DSC, of about 5-250° C. and optionally one or more acetoacetoxy or keto monomers and a polyfunctional amine.

The second copolymer polymer can include an acrylic-based copolymer. In some embodiments, the second copolymer can be derived from (i) one or more hard (meth)acrylate monomers (e.g., from greater than 30% by weight of one or more (meth)acrylate monomers such as methyl (meth)acrylate, n-butyl methacrylate, t-butyl(meth)acrylate, i-butyl methacrylate, cyclohexyl (meth)acrylate, iso bornyl (meth)acrylate and combinations thereof, based on the total weight of the monomers used to form the second copolymer); (ii) one or more acid-containing monomers (from greater than 2% by weight to 30% by weight); (iii) and optionally one or more acetoacetoxy or keto monomers (from greater than 0% by weight to 15% by weight; e.g., acetoacetoxyethyl (meth)acrylate or diacetone acrylamide) and a polyfunctional amine, and (iv) optionally one or more additional ethylenically-unsaturated monomers, excluding monomers (i), (ii) or (iii).

In some instances, the second copolymer can be derived from one or more hard ethylenically-unsaturated monomers selected from the group consisting of methyl (meth)acrylate, styrene, t-butyl methacrylate, cyclohexyl(meth)acrylate, i-butyl methacrylate, iso bornyl (meth)acrylate and combinations thereof. In certain embodiments, the second copolymer can be derived from at least 30% by weight of one or more hard ethylenically-unsaturated monomers selected from the group consisting of methyl (meth)acrylate, styrene, t-butyl (meth)acrylate, cyclohexyl (meth)acrylate, i-butyl methacrylate, iso bornyl (methacrylate) and combinations thereof, based on the total weight of monomers used to form the second copolymer.

Also provided are aqueous compositions comprising one or more of the multistage polymers (or multilayer particles) described above. The aqueous compositions can further include one or more additives, including pigments, fillers, dispersants, coalescents, pH modifying agents, plasticizers, defoamers, surfactants, thickeners, biocides, co-solvents, and combinations thereof. In some cases, the composition can be, for example, a coating composition, such as a paint, a primer, or a paint-and-primer-in-one formulation.

Also provided are methods of making the multistage polymers (or multilayer particles) described herein.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The coating compositions disclosed herein exhibit improved stain removal of a wide variety of hydrophobic and hydrophilic stains. Stain resistance testing was carried out according to modified ASTM D 4828-94 (2012) test method described herein.

The coating compositions disclosed herein include a plurality of polymer particles. The particles can have a particle size, as determined by light scattering and reported as volume average particle size, no greater than 5,000 nm, no greater than 4,000 nm, no greater than 3,000 nm, no greater than 2,000 nm, no greater than 1,000 nm, no greater than 750 nm, no greater than 500 nm, no greater than 400 nm, no greater than 300 nm, no greater than 200 nm, or no greater than 100 nm. In some embodiments, the particles have a particle size from 10-5,000 nm, from 10-4,000 nm, from 10-3,000 nm, from 10-2,000 nm, from 10-1,000 nm, from 10-750 nm, from 10-500 nm, from 10-400 nm, from 10-300 nm, from 10-200 nm, from 10-100 nm, from 10-50 nm, from 50-5,000 nm, from 50-4,000 nm, from 50-3,000 nm, from 50-2,000 nm, from 50-1,000 nm, from 50-750 nm, from 50-500 nm, from 50-400 nm, from 50-300 nm, from 50-200 nm, from 50-100 nm, from 100-1,000 nm, from 100-750 nm, from 100-500 nm, from 100-400 nm, from 100-300 nm, or from 100-200 nm.

The particles can be prepared by polymerizing a monomer mixture, for instance by emulsion polymerization, optionally in the presence of a seed. In some embodiments, the particles can include at least two different copolymers (a multi-stage copolymer), e.g., a first copolymer, a second copolymer, a third copolymer, etc. In some embodiments, the first copolymer, second copolymer, etc. can be prepared in separate reaction vessels, and then combined. In preferred embodiments, the second copolymer, third copolymer, etc. is prepared by polymerizing a monomer mixture in the presence of the first copolymer.

As used herein, the term “(meth)acrylate monomer” includes acrylate, methacrylate, diacrylate, and dimethacrylate monomers.

As used herein, the term “theoretical glass transition temperature” or “theoretical Tg” refers to the estimated Tg of a polymer or copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below:

1/T_{g}=wa/T_{ga}+wb/T_{gb}+ . . . +wi/T_{gi}
where wa is the weight fraction of monomer a in the copolymer, T_{ga} is the glass transition temperature of a homopolymer of monomer a, wb is the weight fraction of monomer b in the copolymer, T_{gb} is the glass transition temperature of a homopolymer of monomer b, wi is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

Provided herein are multistage polymers that comprise (i) a first stage comprising a first copolymer having a first theoretical T_{g}, the first copolymer being derived from a soft ethylenically-unsaturated monomer, and a phosphorus-containing monomer, and optionally an acetoacetoxy or keto monomer and a polyfunctional amine; and (ii) a second stage comprising a second copolymer having a second theoretical Tg, the second copolymer being derived from one or more hard ethylenically-unsaturated monomers, and an acid monomer, and optionally an acetoacetoxy or keto monomer and a polyfunctional amine. The multistage polymers can be in the form of multilayer particles that comprise (i) a first layer comprising a first copolymer having a first theoretical Tg, the first copolymer being derived from one or more soft ethylenically-unsaturated monomer, a phosphorus-containing monomer, and an acetoacetoxy or keto monomer and a polyfunctional amine; and (ii) a second layer surrounding at least a portion of the first layer comprising a second copolymer having a second theoretical Tg, the second copolymer being derived from one or more hard ethylenically-unsaturated monomers, an acid monomer and an acetoacetoxy or keto monomer and a polyfunctional amine.

The multilayer particles can include a first layer and a second layer surrounding at least a portion of the first layer. For example, the multilayer particles can range from core-shell particles to so-called “acorn” particles, wherein the second layer surrounds a substantial portion of the first layer either in a continuous, semi-continuous or discontinuous fashion (e.g., such that the second layer forms at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95% of the particle surface). In some embodiments, the first layer and the second layer form first and second domains within the multilayer particle, wherein the second layer surrounds at least a portion of the first layer.

The weight ratio of the first copolymer (or first layer) to the second copolymer (or second layer) can be at least 95:5 (e.g. at least 90:10, at least 85:15, at least 80:20, at least 75:25, at least 70:30, at least 65:35, at least 60:40, at least 55:45, at least 50:50, at least 45:55, and at least 40:60). The weight ratio of the first copolymer (or first layer) to the second copolymer (or second layer) can be 95:5 or less (e.g. 90:10 or less, 85:15 or less, 80:20 or less, 75:25 or less, 70:30 or less, 65:35 or less, 60:40 or less, 55:45 or less, 50:50 or less, 45:55 or less, and 40:60 or less). The weight ratio of the first polymer to the second polymer can range from any of the minimum values to any of the maximum values described above. For example, the weight ratio of the first polymer to the second polymer can be from 40:60 to 95:5.

In some embodiments, the first copolymer theoretical Tg can be 50° C. or less (e.g., 40 C. or less, 30° C. or less, 25° C. or less, 20° C. or less, 15° C. or less, 10° C. or less, 5° C. or less). In some embodiments, the first copolymer theoretical Tg can be at least −5° C. (e.g., at least 0° C., at least 5° C., at least 10° C., at least 15° C., at least 20° C., at least 25° C., or at least 30° C., at least 40° C. or at least 50° C.).

The first copolymer theoretical Tg can range from any of the minimum values described above to any of the maximum values described above. For example, the first copolymer theoretical Tg can range from −5° C. to 50° C. (e.g., from 0° C. to 35° C., from 5° C. to 35° C., from 10° C. to 35° C., from 10° C. to 25° C., from 15° C. to 35° C., or from 20° C. to 35° C., or from 20° C. to 30° C.).

In some embodiments, the second copolymer theoretical Tg can be at least 5° C. (e.g., at least 10° C., at least 15° C., at least 25° C., at least 30° C., at least 35° C., at least 40° C., at least 45° C., at least 50° C., at least 55° C., at least 60° C., at least 65° C., at least 70° C., or at least 75° C., at least 80° C., at least 85° C., at least 90° C., at least 95° C., at least 100° C.). In some embodiments, the second copolymer theoretical Tg can be 250° C. or less (200° C. or less, 150° C. or less, 125° C. or less, 95° C. or less, 90° C. or less, 85° C. or less, 80° C. or less, 75° C. or less, 70° C. or less, or 65° C. or less, 60° C. or less, 55° C. or less, 50° C. or less, 45° C. or less, 40° C. or less, or 35° C. or less, 30° C. or less, or 25° C. or less).

The second copolymer theoretical Tg can range from any of the minimum values described above to any of the maximum values described above. For example, the second copolymer theoretical Tg can range from 5° C. to 250° C. (e.g., from 20° C. to 200° C., from 20° C. to 150° C., from 20° C. to 125° C., from 20° C. to 110° C., from 20° C. to 100° C., from 30° C. to 90° C., from 40° C. to 80° C., or from 50° C. to 70° C.).

The second copolymer theoretical Tg can be greater than, equal to or less than the first copolymer theoretical Tg. In some embodiments, the second copolymer theoretical Tg can be at least 10° C. greater than the first copolymer theoretical Tg (e.g., at least 15° C. greater, at least 20° C. greater, at least 25° C. greater, at least 30° C. greater, at least 35° C. greater, at least 40° C. greater, at least 45° C. greater, at least 50° C. greater, at least 55° C. greater, at least 60° C. greater, at least 75° C. greater, at least 80° C. greater, at least 90° C. greater, at least 100° C. greater or at least 110° C. greater.). In some embodiments, the second copolymer theoretical Tg can be at least 5° C. less than the first copolymer theoretical Tg.

In some embodiments, the multistage polymer (or the multilayer particle) exhibits a single Tg, measured using differential scanning calorimetry (DSC), of at least −10° C. (e.g., at least −5° C., at least 0° C., at least 5° C., at least 10° C., at least 15° C., or at least 20° C., at least 25° C., at least 30° C., or at least 35° C.). In some embodiments, the multistage polymer (or the multilayer particle) exhibits a single Tg, measured using DSC, of 35° C. or less (e.g., 30° C. or less, 25° C. or less, 20° C. or less, 15° C. or less, 10° C. or less, 5° C. or less, 0° C. or less, or −5° C. or less).

The multistage polymer (or the multilayer particle) can exhibit a single Tg, measured using DSC, ranging from any of the minimum values described above to any of the maximum values described above. For example, the multistage polymer (or the multilayer particle) can exhibit a single Tg, measured using DSC, from −5° C. to 35° C. (e.g., from 0° C. to 25° C., or from 5° C. to 20° C.). The glass transition temperature can be determined by differential scanning calorimetry (DSC) by measuring the midpoint temperature using ASTM D 3418-12el.

The first copolymer and the second copolymer can be derived from ethylenically-unsaturated monomers. Exemplary ethylenically-unsaturated monomers include (meth)acrylate monomers, vinyl aromatic monomers (e.g., styrene), ethylenically unsaturated aliphatic monomers (e.g., butadiene), vinyl ester monomers (e.g., vinyl acetate), and combinations thereof.

In some embodiments, the first copolymer can include an acrylic-based copolymer. Acrylic-based copolymers include copolymers derived from one or more (meth)acrylate monomers. The acrylic-based copolymer can be a pure acrylic polymer (i.e., a copolymer derived primarily from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

In some embodiments, the first copolymer is derived from:
(i) one or more soft (meth)acrylate monomers;
(ii) one or more phosphorus-containing monomers, and
(iii) optionally one or more acetoacetoxy, keto or aldehyde monomers and a polyfunctional amine; and
(iv) optionally one or more additional ethylenically-unsaturated monomers, excluding monomers (i), (ii), and (iii).

The first copolymer can be derived from one or more soft ethylenically-unsaturated monomers. As used herein, the term “soft ethylenically-unsaturated monomer” refers to an ethylenically-unsaturated monomer that, when homopolymerized, forms a polymer having a glass transition temperature, as measured using differential scanning calorimetry (DSC), of 0° C. or less. Soft ethylenically-unsaturated monomers are known in the art, and include, for example, ethyl acrylate (Tg=−24° C.), n-butyl acrylate, (Tg=−54° C.), sec-butyl acrylate (Tg=−26° C.), n-hexyl acrylate (Tg=−45° C.), n-hexyl methacrylate (Tg=−5° C.), 2-ethylhexyl acrylate (Tg=−85° C.), 2-ethylhexyl methacrylate (Tg=−10° C.), octyl methacrylate (Tg=−20° C.), n-decyl methacrylate (Tg=−30° C.), isodecyl acrylate (Tg=−55° C.), dodecyl acrylate (Tg=−3° C.), dodecyl methacrylate (Tg=−65° C.), 2-ethoxyethyl acrylate (Tg=−50° C.), 2-methoxy acrylate (Tg=−50° C.), and 2-(2-ethoxyethoxy)ethyl acrylate (Tg=−70° C.).

In some embodiments, the first copolymer can be derived from a soft ethylenically-unsaturated monomer that, when homopolymerized, forms a polymer having a glass transition temperature, as measured using DSC, of −10° C. or less (e.g., −20° C. or less, −30° C. or less, −40° C. or less, −50° C. or less, −60° C. or less, −70° C. or less, or −80° C. or less). In certain embodiments, the soft ethylenically-unsaturated monomer can be a (meth)acrylate monomer. In certain embodiments, the first copolymer can be derived from a soft ethylenically-unsaturated monomer selected from the group consisting of n-butyl acrylate, ethyl acrylate, sec-butyl acrylate, 2-ethylhexyl (meth)acrylate, and combinations thereof.

The first copolymer can be derived from at least 10% to at most 85% by weight of one or more soft ethylenically-unsaturated monomers, based on the total weight of the monomers used to form the first copolymer (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, or at least 80% by weight). The first copolymer can be derived from at most 85% by weight of one or more soft ethylenically-unsaturated monomers, based on the total weight of the monomers used to form the first copolymer (e.g., at most 80% by weight, at most 75% by weight, at most 70% by weight, at most 65% by weight, at most 60% by weight, at most 55% by weight, at most 50% by weight, at most 45% by weight, at most 40% by weight, at most 35% by weight, at most 30% by weight, at most 25% by weight, at most 20% by weight, or at most 15% by weight).

The first copolymer can be derived from an amount of one or more soft ethylenically-unsaturated monomers ranging from any of the minimum percentages described above to any of the maximum percentages described above. For example, the first copolymer can be derived from 15% to 85% by weight of one or more soft ethylenically-unsaturated monomers, based on the total weight of the monomers used to form the first copolymer (e.g., from 15% to 60% by weight, from 25% to 60% by weight, from 30% to 60% by weight, or from 35% to 55% by weight).

The first polymer can be derived from one or more phosphorous acid-containing monomers based on the total weight of monomers. Ammonium, alkali metal ion, alkaline earth metal ion and other metal ion salts of these acids can also be used. Suitable phosphorus-containing monomers are vinylphosphonic acid and allylphosphonic acid, for example. Also suitable are the monoesters and diesters of phosphonic acid and phosphoric acid with hydroxyalkyl(meth)acrylates, especially the monoesters. Additionally suitable monomers are diesters of phosphonic acid and phosphoric acid that have been esterified once with hydroxyalkyl(meth)acrylate and also once with a different alcohol, such as an alkanol, for example. Suitable hydroxyalkyl(meth)acrylates for these esters are those specified below as separate monomers, more particularly 2-hydroxyethyl(meth)acrylate, 3-hydroxypropyl(meth)acrylate, 4-hydroxybutyl(meth)acrylate, etc. Corresponding dihydrogen phosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide or propylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Of further suitability are phosphoalkyl crotonates, phosphoalkyl maleates, phosphoalkyl fumarates, phosphodialkyl(meth)acrylates, phosphodialkyl crotonates and allyl phosphates.

Examples of phosphate containing unsaturated monomers are Sipomer® PAM 4000, Sipomer® PAM 200, Sipomer® PAM 100, and Sipomer PAM 600. Alkali or alkaline earth metal ion or ammonia neutralized salts of the above acids and combinations thereof can also be used. In some instances, the monomer mixture can include a mixture of ethylenically unsaturated acids, for instance (meth)acrylic acid and phosphorous acid containing monomers, or itaconic acid and phosphorous acid containing monomers or combination of carboxylic and phosphorous acid containing monomers. Alkali or alkaline earth metal ion or ammonia neutralized salts of the above acids and combinations thereof can also be used.

The first copolymer can be derived from greater than 0% by weight of one or more phosphorus-containing monomers, based on the total weight of the monomers used to form the first copolymer (e.g., at least 0.25% by weight, at least 0.5% by weight, at least 1% by weight, at least 1.5% by weight, at least 2% by weight, at least 2.5% by weight, at least 3% by weight, at least 3.5% by weight, at least 4% by weight, or at least 4.5% by weight or at least 5% by weight or at least 10% by weight). The first copolymer can be derived from 10% or less by weight of one or more phosphorus-containing monomers, based on the total weight of the monomers used to form the first copolymer (e.g., from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight, or from 0.25% or less by weight).

The first copolymer can be derived from an amount of one or more phosphorus-containing monomers ranging from any of the minimum percentages described above to any of the maximum percentages described above. For example, the first copolymer can be derived from greater than 0% by weight to 10% by weight of one or more phosphorus-containing monomers, based on the total weight of the monomers used to form the first copolymer (e.g., from greater than 0% by weight to 5% by weight of one or more phosphorus-containing monomers or from greater than 0% by weight to 2.5% by weight of one or more phosphorus-containing monomers). In certain embodiments, the first copolymer is derived from greater than 0% by weight to 10% by weight (e.g., greater than 0% by weight to 5% by weight, greater than 0% by weight to 3% by weight, greater than 0% by weight to 2.5% by weight, or greater than 0% by weight to 1.5% by weight) 2-phosphoethyl methacrylate (PEM).

The first copolymer can be derived from one or more acetoacetoxy, keto or aldehyde monomers or a combination there of. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below:

CH2=CR1C(O)NR2C(O)R3
wherein R1 is hydrogen or methyl; R2 is hydrogen, a C1-C4 alkyl group, or a phenyl group; and R3 is hydrogen, a C1-C4 alkyl group, or a phenyl group. For example, the (meth)acrylamide derivative can be diacetone acrylamide (DAAM) or diacetone methacrylamide. Suitable aldehyde monomers include (meth)acrolein.

The first copolymer can be derived from greater than 0% by weight of one or more acetoacetoxy, keto or aldehyde monomers, based on the total weight of the monomers used to form the first copolymer (e.g., at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, at least 9.5% by weight, at least 10% by weight or at least 15% by weight). The first copolymer can be derived from 15% or less by weight of one or more acetoacetoxy, keto or aldehyde monomers, based on the total weight of the monomers used to form the first copolymer (e.g., from 10% or less by weight, from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight).

Acetoacetoxy, keto or aldehyde groups can be reacted with polyamines to form crosslinks. Polyamines with primary amine groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and dytek. In some embodiments amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments amines includeDytek A, Dytek EP, Dytek HMD, Dytek BHMT, and Dytek DCH-99. In some embodiments, amines are polyhydrazides derived from alipahtic and aromatic polycarboxylic acids including adipic dihydrazide, succinic dihydrazide, citric trihydrazide, isophthalic dihydrazide, phthalic dihydrazide, trimellitic trihydrazide, etc. Other amines include diethylenetriamine, triethylenetetramine, tetraethylenepentamine, pentaethylenehexamine, hexaethyleneheptamine, heptaethyleneoctamine, 5 octaethylenenonamine, higher polyimines e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine. The preferred amines are polyhydrazides when diacetone acrylamide and its derivative monomer are used.

The acetoacetoxy, keto or aldehyde group to primary amine group ratio varies between 1:0.4 equivalents to 1:1.2 equivalents (e.g., 1:0.5 equivalents to 1:1.1 equivalents, 1:0.6 equivalents to 1:1 equivalents, 1:0.7 equivalents to 1:1 equivalents, 1:0.8 equivalents to 1:1 equivalents, 1:0.9 equivalents to 1:1 equivalents). For example the acetoacetoxy, keto or aldehyde group to primary amine groups ratio is 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, or 1;1.2.

The first copolymer can be derived from an amount of one or more acetoacetoxy, keto or aldehyde monomers ranging from any of the minimum percentages described above to any of the maximum percentages described above. For example, the first copolymer can be derived from greater than 0% by weight to 10% by weight of one or more acetoacetoxy, keto or aldehyde monomers, based on the total weight of the monomers used to form the first copolymer (e.g., from 0.25% by weight to 10% by weight of one or more acetoacetoxy, keto or aldehyde monomers, from 0.5% by weight to 5% by weight of one or more acetoacetoxy, keto or aldehyde monomers, from 1% by weight to 7.5% by weight of one or more acetoacetoxy, keto or aldehyde monomers, from 2.5% by weight to 7.5% by weight of one or more acetoacetoxy, keto or aldehyde monomers, or from 5% by weight to 7.5% by weight of one or more acetoacetoxy, keto or aldehyde monomers). In certain embodiments, the first copolymer is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the first copolymer is derived from greater than 0% by weight to 10% by weight (e.g., from 0.25% by weight to 10% by weight, from 0.5% by weight to 5% by weight, from 1% by weight to 7.5% by weight, from 2.5% by weight to 7.5% by weight, or from 5% by weight to 7.5% by weight) of diacetone acrylamide (DAAM).

Other crosslinking monomers which carry epoxide groups, such as glycidyl methacrylate (GMA), or monomers which carry alkoxy silane groups, such as vinyltrirthoxy silane, vinyl trimethoxy silane, (meth)acryloxy propyl triethoxy silane, and (meth)acryloxy propyl trimethoxy silane or multiolefinically unsaturated compounds such as allyl(meth)acrylate (AMA), butanediol di(meth)acrylate, hexanediol di(meth)acrylate, trimethylolpropane tri(meth)acrylate, and pentaerythritol tetra(meth)acryalte can also be used.

The first copolymer can be derived from one or more additional ethylenically-unsaturated monomers (e.g., (meth)acrylate monomers, vinyl aromatic monomers, etc.) as described below in addition to one or more soft ethylenically-unsaturated monomers, one or more phosphorus-containing monomers, and one or more acetoacetoxy monomers, keto or aldehyde monomers.

The first copolymer can be derived from greater than 0% by weight to 55% by weight of one or more additional ethylenically-unsaturated monomers. Additional ethylenically unsaturated monomers include (meth)acrylate monomers. These meth(acrylate) monomers include esters of α-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof. In some embodiments, the first copolymer is derived from one or more (meth)acrylate monomers selected from the group consisting of methyl methacrylate, n-butyl acrylate, 2-ethylhexylacrylate, and combinations thereof. In some embodiments, the first copolymer is derived from methyl methacrylate and n-butyl acrylate.

In first copolymer additional ethylenically unsaturated monomers include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth)acrylamide, adhesion promoting ureido functional (Meth)acrylate monomer, a (meth)acrylamide derivative, a sulfur-based monomer, or a combination of these monomers.

Suitable vinyl aromatic compounds include styrene, α- and β-methylstyrene, α-butylstyrene, 4-n-butylstyrene, 4-n-decylstyrene, vinyltoluene, and combinations thereof. Vinyl esters of carboxylic acids with alkanols having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Alkoxy silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylalkoxysilanes, such as (meth)acryloyloxypropyltrimethoxysilane, γ-(meth)acryloxypropyltrimethoxysilane, and γ-(meth)acryloxypropyltriethoxysilane. Sulfur-containing monomers include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. When present, the sulfur-containing monomers are generally present in an amount greater than 0% by weight to 5% by weight.

In certain embodiments, the first copolymer is derived from
(i) 35-60% by weight n-butyl acrylate;
(ii) greater than 0 to 5% by weight one or more phosphorus containing monomers;
(iii) and greater than 0 to 10% by weight one or more acetoacetoxy or keto monomers and a polyfunctional amine.
(iv) optionally one or more additional ethylenically-unsaturated monomers, excluding monomers (i), (ii), and (iii).

The second copolymer can be derived from ethylenically-unsatured monomers. In some embodiments, the second copolymer includes an acrylic-based polymer. Acrylic-based polymers include polymers derived from one or more (meth)acrylate monomers. The acrylic-based polymer can be a pure acrylic polymer (i.e., a polymer derived exclusively from (meth)acrylate monomers), a styrene-acrylic polymer (i.e., a copolymer derived from styrene and one or more (meth)acrylate monomers), or a vinyl-acrylic polymer (i.e., a copolymer derived from one or more vinyl ester monomers and one or more (meth)acrylate monomers).

In some embodiments, the second copolymer is derived from:
(i) one or more hard (meth)acrylate monomers;
(ii) one or more acid-containing monomers, and
(iii) optionally one or more acetoacetoxy, keto or aldehyde monomers and a polyfunctional amine; and
(iv) optionally one or more additional ethylenically-unsaturated monomers, excluding monomers (i), (ii), and (iii).

The second copolymer can be derived from one or more hard ethylenically-unsaturated monomers. As used herein, the term “hard ethylenically-unsaturated monomer” refers to an ethylenically-unsaturated monomer that, when homopolymerized, forms a polymer having a Tg, as measured using DSC, of greater than 0° C. Hard ethylenically-unsaturated monomers are known in the art, and include, for example, methyl acrylate (Tg=10° C.), methyl methacrylate (Tg=105° C.), ethyl methacrylate (Tg=65° C.), n-butyl methacrylate (Tg=20° C.), tert-butyl methacrylate (Tg=118° C.), tert-butyl acrylate (Tg=45° C.), isobutyl methacrylate (Tg=53° C.), vinyl acetate (Tg=30° C.), hydroxyethyl acrylate (Tg=15° C.), hydroxyethyl methacrylate (Tg=57° C.), cyclohexyl acrylate (Tg=19° C.), cyclohexyl methacrylate (Tg=92° C.), 2-ethoxyethyl methacrylate (Tg=16° C.), 2-phenoxyethyl methacrylate (Tg=54° C.), benzyl acrylate (Tg=6° C.), benzyl methacrylate (Tg=54° C.), hydroxypropyl methacrylate (Tg=76° C.), styrene (Tg=100° C.), 4-acetostyrene (Tg=116° C.), acrylamide (Tg=165° C.), acrylonitrile (Tg=125° C.), 4-bromostyrene (Tg=118° C.), n-tert-butylacrylamide (Tg=128° C.), 4-tert-butylstyrene (Tg=127° C.), 2,4-dimethylstyrene (Tg=112° C.), 2,5-dimethylstyrene (Tg=143° C.), 3,5-dimethylstyrene (Tg=104° C.), isobornyl acrylate (Tg=94° C.), isobornyl methacrylate (Tg=110° C.), 4-methoxystyrene (Tg=113° C.), methylstyrene (Tg=20° C.), 4-methylstyrene (Tg=97° C.), 3-methylstyrene (Tg=97° C.), 2,4,6-trimethylstyrene (Tg=162° C.), and combinations thereof.

In some embodiments, the second copolymer can be derived from one or more hard ethylenically-unsaturated monomers that, when homopolymerized, form a polymer having a Tg, as measured using DSC, of at least 80° C. (e.g., at least 85° C., at least 90° C., at least 95° C., at least 100° C., at least 105° C., at least 110° C., at least 115° C., or at least 120° C.).

In some embodiments, the second copolymer can be derived from one or more hard ethylenically-unsaturated monomers that, when homopolymerized, form a polymer having a Tg, as measured using DSC, of at least 40° C. (e.g., at least 45° C., at least 50° C., at least 55° C., at least 60° C., at least 65° C., at least 70° C., at least 75° C., or at least 80° C.).

In some embodiments, the second copolymer can be derived from one or more hard ethylenically-unsaturated monomers that, when homopolymerized, form a polymer having a Tg, as measured using DSC, of at least 8° C. (e.g., at least 18° C., at least 40° C., at least 50° C., at least 55° C., at least 60° C., at least 65° C., at least 70° C., at least 75° C., or at least 80° C.).

In some embodiments, the second copolymer can be derived from greater than 30% by weight of one or more hard ethylenically-unsaturated monomers (e.g., 40% by weight or greater, 50% by weight or greater, 55% by weight or greater, 60% by weight or greater, 65% by weight or greater, 70% by weight or greater, 75% by weight or greater, 80% by weight or greater, 85% by weight or greater, 88% by weight or greater, 90% by weight or greater, 91% by weight or greater, 92% by weight or greater, 93% by weight or greater, 94% by weight or greater, or 95% by weight or greater of the hard ethylenically-unsaturated monomer) based on the total weight of monomers used to form the second copolymer.

In some embodiments, the second copolymer can be derived from less than 95% by weight of one or more hard ethylenically-unsaturated monomers (e.g., 90% or less by weight, 85% or less by weight, 80% or less by weight, 75% or less by weight, 70% or less by weight, 65% or less by weight, 60% or less by weight, 55% or less by weight, 50% or less by weight, 45% or less by weight, 40% or less by weight, 35% or less by weight) based on the total weight of monomers used to form the second copolymer.

The second copolymer can be derived from greater than 2% by weight of one or more acid-containing monomers, based on the total weight of the monomers used to form the second copolymer (e.g., at least 3% by weight, at least 4% by weight, at least 5% by weight, at least 6% by weight, at least 7% by weight, at least 8% by weight, at least 9% by weight at least 10% by weight, at least 15% by weight, at least 20% by weight, at least 25% by weight). The second copolymer can be derived from 30% or less by weight of one or more acid-containing monomers, based on the total weight of the monomers used to form the second copolymer (e.g., from 25% or less by weight, from 20% or less by weight, from 15% or less by weight, from 10% or less by weight, or from 5% or less by weight).

The second copolymer can be derived from an amount of one or more acid-containing monomers ranging from any of the minimum percentages described above to any of the maximum percentages described above. For example, the second copolymer can be derived from greater than 2% by weight to 30% by weight of one or more acid-containing monomers, based on the total weight of the monomers used to form the second copolymer (e.g., from greater than 2% by weight to 20% by weight of one or more acid-containing monomers). In certain embodiments, the second copolymer is derived from greater than 2% by weight to 30% by weight (e.g., greater than 2% by weight to 10% by weight, greater than 2% by weight to 15% by weight, or greater than 2% by weight to 20% by weight) acid monomers.

The second copolymer can be derived from one or more carboxylic acid-containing monomers. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The second copolymer can be derived from one or more sulfur acid-containing monomers. Suitable sulfur acid monomers are vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid and their ionic salts with ammonium and metal ions. Suitable styrenesulfonic acids and derivatives thereof are styrene-4-sulfonic acid and styrene-3-sulfonic acid and alkali metal ion, alkaline earth metal ion, salts thereof, such as sodium styrene-3-sulfonate and sodium styrene-4-sulfonate.

The second copolymer can be derived from one or more phosphorous acid-containing monomers based on the total weight of monomers. Ammonium, alkali metal ion, alkaline earth metal ion and other metal ion salts of these acids can also be used. Suitable phosphorus-containing monomers are vinylphosphonic acid and allylphosphonic acid, for example. Also suitable are the monoesters and diesters of phosphonic acid and phosphoric acid with hydroxyalkyl(meth)acrylates, especially the monoesters. Additionally suitable monomers are diesters of phosphonic acid and phosphoric acid that have been esterified once with hydroxyalkyl(meth)acrylate and also once with a different alcohol, such as an alkanol, for example. Suitable hydroxyalkyl(meth)acrylates for these esters are those specified below as separate monomers, more particularly 2-hydroxyethyl(meth)acrylate, 3-hydroxypropyl(meth)acrylate, 4-hydroxybutyl(meth)acrylate, etc. Corresponding dihydrogen phosphate ester monomers comprise phosphoalkyl(meth)acrylates, such as 2-phosphoethyl(meth)acrylate, 2-phosphopropyl(meth)acrylate, 3-phosphopropyl(meth)acrylate, phosphobutyl(meth)acrylate, and 3-phospho-2-hydroxypropyl(meth)acrylate. Also suitable are the esters of phosphonic acid and phosphoric acid with alkoxylated hydroxyalkyl(meth)acrylates, examples being the ethylene oxide or propylene oxide condensates of (meth)acrylates, such as H₂C═C(CH₃)COO(CH₂CH₂O)ₙP(OH)₂ and H₂C═C(CH₃)COO(CH₂CH₂O)ₙP(═O)(OH)₂, in which n is 1 to 50. Of further suitability are phosphoalkyl crotonates, phosphoalkyl maleates, phosphoalkyl fumarates, phosphodialkyl(meth)acrylates, phosphodialkyl crotonates and allyl phosphates.

Examples of phosphate containing unsaturated monomers are Sipomer® PAM 4000, Sipomer® PAM 200, Sipomer® PAM 100, and Sipomer PAM 600. In some instances, the monomer mixture can include a mixture of ethylenically unsaturated acids, for instance (meth)acrylic acid and phosphorous acid containing monomers, or itaconic acid and phosphorous acid containing monomers or combination of carboxylic and phosphorous acid containing monomers. Alkali or alkaline earth metal ion or ammonia neutralized salts of the above acids and combinations thereof can also be used.

The second copolymer can be derived from greater than 2% by weight of one or more acid-containing monomers, based on the total weight of the monomers used to form the second copolymer (e.g., at least 3% by weight, at least 4% by weight, at least 5% by weight, at least 10% by weight, at least 15% by weight, at least 20% by weight, at least 25% by weight). The second copolymer can be derived from 30% or less by weight of one or more acid-containing monomers, based on the total weight of the monomers used to form the second copolymer (e.g., from 25% or less by weight, from 20% or less by weight, from 15% or less by weight, from 10% or less by weight, or from 5% or less by weight).

The second copolymer can be derived from an amount of one or more acid-containing monomers ranging from any of the minimum percentages described above to any of the maximum percentages described above. For example, the second copolymer can be derived from greater than 2% by weight to 30% by weight of one or more acid-containing monomers, based on the total weight of the monomers used to form the second copolymer (e.g., from greater than 2% by weight to 20% by weight of one or more acid-containing monomers). In certain embodiments, the second copolymer is derived from greater than 2% by weight to 30% by weight (e.g., greater than 2% by weight to 10% by weight, greater than 2% by weight to 15% by weight, or greater than 2% by weight to 20% by weight) carboxylic acid monomers

The second copolymer can be derived from one or more acetoacetoxy, keto or aldehyde monomers or a combination there of. Suitable acetoacetoxy monomers are known in the art, and include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Suitable keto monomers include diacetone acrylamide (DAAM). Keto monomers include keto-containing amide functional monomers defined by the general structure below:

CH2=CR1C(O)NR2C(O)R3
wherein R1 is hydrogen or methyl; R2 is hydrogen, a C1-C4 alkyl group, or a phenyl group; and R3 is hydrogen, a C1-C4 alkyl group, or a phenyl group. For example, the (meth)acrylamide derivative can be diacetone acrylamide (DAAM) or diacetone methacrylamide. Suitable aldehyde monomers include (meth)acrolein.

The second copolymer can be derived from greater than 0% by weight of one or more acetoacetoxy, keto, or aldehyde monomers, based on the total weight of the monomers used to form the first copolymer (e.g., at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, at least 5% by weight, at least 5.5% by weight, at least 6% by weight, at least 6.5% by weight, at least 7% by weight, at least 7.5% by weight, at least 8% by weight, at least 8.5% by weight, at least 9% by weight, at least 9.5% by weight, at least 10% by weight or at least 15% by weight). The first copolymer can be derived from 15% or less by weight of one or more acetoacetoxy, keto or aldehyde monomers, based on the total weight of the monomers used to form the first copolymer (e.g., from 10% or less by weight, from 9.5% or less by weight, from 8% or less by weight, from 8.5% or less by weight, from 8% or less by weight, from 7.5% or less by weight, from 7% or less by weight, from 6.5% or less by weight, from 6% or less by weight, from 5.5% or less by weight, from 5% or less by weight, from 4.5% or less by weight, from 4% or less by weight, from 3.5% or less by weight, from 3% or less by weight, from 2.5% or less by weight, from 2% or less by weight, from 1.5% or less by weight, from 1% or less by weight, or from 0.5% or less by weight). In certain embodiments, the second copolymer is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the second copolymer is derived from greater than 0% by weight to 10% by weight (e.g., from 0.25% by weight to 5% by weight, from 0.5% by weight to 5% by weight, from 1% by weight to 7.5% by weight, from 2.5% by weight to 7.5% by weight, or from 5% by weight to 7.5% by weight) of diacetone acrylamide (DAAM).

Acetoacetoxy, keto or aldehyde groups can be reacted with polyamines to form crosslinkes. Polyamines with primary amine groups are preferred. Examples of suitable polyfunctional amines include polyetheramines, polyalkyleneamines, polyhydrazides, or a combination thereof. Specific examples of polyfunctional amines include polyfunctional amines sold under the trade names, Baxxodur, Jeffamine, and dytek. In some embodiments amines are difunctional or higher functional. Polyfunctional amine-terminated polyoxyalkylene polyols (e.g., Jeffamines or Baxxodur amines), examples being polyetheramine T403, polyetheramine D230, polyetheramine D400, polyetheramine D2000, or polyetheramine T5000). In some embodiments amines includeDytek A, Dytek EP, Dytek HMD, Dytek BHMT, and Dytek DCH-99. In some embodiments, amines are polyhydrazides derived from alipahtic and aromatic polycarboxylic acids including adipic dihydrazide, succinic dihydrazide, citric trihydrazide, isophthalic dihydrazide, phthalic dihydrazide, trimellitic trihydrazide, etc. Other amines include diethylenetriamine, triethylenetetramine, tetraethylenepentamine, pentaethylenehexamine, hexaethyleneheptamine, heptaethyleneoctamine, 5 octaethylenenonamine, higher polyimines e.g., polyethyleneimines and polypropyleneimines, bis(3-aminopropyl)amine, bis(4-aminobutyl)amine, bis(5-aminopentyl)amine, bis(6-aminohexyl)amine, 3-(2-aminoethyl)aminopropylamine, N,N-bis(3-aminopropyl)ethylenediamine, N′,N-bis(3-aminopropyl)ethylenediamine, N,N-bis(3-aminopropyl)propane-1,3-diamine, N,N-bis(3-10 aminopropyl)butane-1,4-diamine, N,N′-bis(3-aminopropyl)propane-1,3-diamine, N,N′-bis(3-aminopropyl)butane-1,4-diamine, N,N,N′N′-tetra(3-aminopropyl)ethylenediamine, N,N,N′N′-tetra(3-aminopropyl)-1,4-butylenediamine, tris(2-aminoethyl)amine, tris(2-aminopropyl)amine, tris(3-aminopropyl)amine, tris(2-aminobutyl)amine, tris(3-aminobutyl)amine, tris(4-aminobutyl)amine, tris(5-aminopentyl)amine, tris(6-aminohexyl)amine, trisaminohexane, trisaminononane, 4-aminomethyl-1,8-octamethylenediamine. The preferred polyamines are polyhyrazides when diacetone acrylamide and its derivative monomers are used.

The acetoacetoxy, keto, or aldehyde group to primary amine group ratio varies between 1:0.4 equivalents to 1:1.2 equivalents (e.g., 1:0.5 equivalents to 1:1.1 equivalents 1:0.6 equivalents to 1:1 equivalents, 1:0.7 equivalents to 1:1 equivalents 1:0.8 equivalents to 1:1 equivalents, 1:0.9 equivalents to 1:1 equivalents). For example the acetoacetoxy, keto or aldehyde group to primary amine groups ratio is 1:0.4, 1:0.45, 1:0.5, 1:0.55, 1:0.6, 1:0.65, 1:0.7, 1:0.75, 1:0.8, 1:0.85, 1:0.9, 1:0.95, 1:1, 1:1.05, 1:1.1, 1:1.15, or 1;1.2.

The second copolymer can be derived from an amount of one or more acetoacetoxy, keto, or aldehyde monomers ranging from any of the minimum percentages described above to any of the maximum percentages described above. For example, the first copolymer can be derived from greater than 0% by weight to 10% by weight of one or more acetoacetoxy, keto or aldeyde monomers, based on the total weight of the monomers used to form the first copolymer (e.g., from 0.25% by weight to 5% by weight of one or more acetoacetoxy, keto or aldehyde monomers, from 0.5% by weight to 5% by weight of one or more acetoacetoxy, keto or aldehyde monomers, from 1% by weight to 7.5% by weight of one or more acetoacetoxy monomers, keto, or aldehyde, from 2.5% by weight to 7.5% by weight of one or more acetoacetoxy, keto or aldehyde, monomers, or from 5% by weight to 7.5% by weight of one or more acetoacetoxy, keto, or aldehyde monomers). In certain embodiments, the first copolymer is derived from greater than 0% by weight to 10% by weight (e.g., from 1% by weight to 7.5% by weight, from 2.5% by weight to 7.5% by weight, or from 5% by weight to 7.5% by weight) acetoacetoxyethyl (meth)acrylate (AAEM). In certain embodiments, the first copolymer is derived from greater than 0% by weight to 10% by weight (e.g., from 1% by weight to 7.5% by weight, from 2.5% by weight to 7.5% by weight, or from 5% by weight to 7.5% by weight) diacetone acrylamide (DAAM).

The second copolymer can be derived from one or more crosslinking monomers which carry epoxide groups, such as glycidyl methacrylate (GMA), or monomers which carry alkoxy silane groups, such as vinyltriethoxy silane, vinyl trimethoxy silane, (meth)acryloxy propyl triethoxy silane, and (meth)acryloxy propyl trimethoxy silane or multiolefinically unsaturated compounds such as allyl(meth)acrylate (AMA), butanediol di(meth)acrylate, hexanediol di(meth)acrylate, trimethylolpropane tri(meth)acrylate and pentaerythritol tetra(meth)acrylate.

The second copolymer can be derived from one or more additional ethylenically-unsaturated monomers (e.g., (meth)acrylate monomers, vinyl aromatic monomers, etc.) as described below in addition to one or more hard ethylenically-unsaturated monomers, one or more acid-containing monomers, and one or more acetoacetoxy monomers, keto or aldehyde monomers.

In some embodiments the second copolymer can be derived from greater than 0% by weight to 50% by weight of one or more additional ethylenically-unsaturated monomers. Additional ethylenically unsaturated monomers include (meth)acrylate monomers. These meth(acrylate) monomers include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary acrylate and methacrylate monomers include, but are not limited to, methyl (meth)acrylate, ethyl (meth)acrylate, n-butyl (meth)acrylate, iso-butyl (meth)acrylate, t-butyl (meth)acrylate, 2-ethylhexyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethylenegly col (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, trimethylolpropane tri(meth)acrylate, pentaerythritol tetra(meth)acrylate and combinations thereof.

In second copolymer additional ethylenically unsaturated monomers include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a alkoxy silane-containing monomer, a (meth)acrylamide, adhesion promoting ureido functional (Meth)acrylate monomer, a (meth)acrylamide derivative, a sulfur-based monomer, or a combination of these monomers.

Suitable vinyl aromatic compounds include styrene, α- and β-methylstyrene, α-butylstyrene, 4-n-butylstyrene, 4-n-decylstyrene, vinyltoluene, and combinations thereof. Vinyl esters of carboxylic acids with alkanols having up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Alkoxy silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylalkoxysilanes, such as (meth)acryloyloxypropyltrimethoxysilane, γ-(meth)acryloxypropyltrimethoxysilane, and γ-(meth)acryloxypropyltriethoxysilane.

In certain embodiments, the second copolymer is derived from
(i) 35-60% by weight methyl(meth)acrylate, t-butyl (meth)acrylate, i-butyl methacrylate, styrene, cyclohexyl(meth)acrylate or combinations there of
(ii) greater than 0 to 15% by weight one or more carboxylic acid containing monomers;
(iii) and greater than 0 to 10% by weight one or more acetoacetoxy, keto or aldehyde monomers and a polyfunctional amine, and
(iv) optionally one or more additional ethylenically-unsaturated monomers, excluding monomers (i), (ii), and (iii).

Also provided are aqueous compositions comprising one or more of the multistage polymers (or multilayer particles) described above. The aqueous compositions can further include one or more additives, including pigments, fillers, dispersants, coalescents, pH modifying agents, plasticizers, defoamers, surfactants, thickeners, biocides, co-solvents, and combinations thereof. The choice of additives in the composition will be influenced by a number of factors, including the nature of the multistage polymers (or multilayer particles) dispersed in the aqueous composition, as well as the intended use of the composition. In some cases, the composition can be, for example, a coating composition, such as a paint, a primer, or a paint-and-primer-in-one formulation. In some embodiments, the composition comprises less than or equal to 50 grams per liter of volatile organic compounds.

Examples of suitable pigments include metal oxides, such as titanium dioxide, zinc oxide, iron oxide, or combinations thereof. In certain embodiments, the composition includes a titanium dioxide pigment. Examples of commercially titanium dioxide pigments are KRONOS® 2101, KRONOS® 2310, KRONOS® 4311, available from Kronos WorldWide, Inc. (Cranbury, N.J.), TI-PURE® R-900, TI-PURE® R-746. TI-PURE® R-706, available from DuPont (Wilmington, Del.), or TIONA® AT1 commercially available from Millenium Inorganic Chemicals. Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Examples of suitable pH modifying agents include amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Defoamers serve to minimize frothing during mixing and/or application of the coating composition. Suitable defoamers include silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.).

Suitable surfactants include nonionic surfactants and anionic surfactants. Examples of nonionic surfactants are alkylphenoxy polyethoxyethanols having alkyl groups of about 7 to about 18 carbon atoms, and having from about 6 to about 60 oxyethylene units; ethylene oxide derivatives of long chain carboxylic acids; analogous ethylene oxide condensates of long chain alcohols, and combinations thereof. Exemplary anionic surfactants include ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers include ethylene glycol, propylene glycol, diethylene glycol, and combinations thereof.

Other suitable additives that can optionally be incorporated into the composition include rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, insecticides, lubricants, odorants, oils, waxes and slip aids, soil repellants, stain resisting agents, and combinations thereof.

Coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating.

The coating compositions can be applied to a variety of surfaces including, but not limited to metal, asphalt, concrete, stone, ceramic, wood, plastic, polyurethane foam, glass, wall board coverings (e.g., drywall, cement board, etc.), and combinations thereof. The coating compositions can be applied to interior or exterior surfaces. In certain embodiments, the surface is an architectural surface, such as a roof, dry wall, floor, wood, plastic, or combination thereof. The architectural surface can be located above ground, below ground, or combinations thereof.

Also provided are coatings formed from the coating compositions described herein. Generally, coatings are formed by applying a coating composition described herein to a surface, and allowing the coating to dry to form a coating. The coating thickness can vary depending upon the application of the coating.

Also provided are methods of making the multistage polymers and multilayer particles described above. The multistage polymers and multilayer particles described above can be prepared by heterophase polymerization techniques, including, for example, free-radical emulsion polymerization, suspension polymerization, and mini-emulsion polymerization. In some examples, the multistage polymer is prepared by polymerizing the monomers using free-radical emulsion polymerization. The emulsion polymerization temperature can range from 10° C. to 130° C. (e.g., from 50° C. to 90° C.). The polymerization medium can include water alone or a mixture of water and water-miscible liquids, such as methanol, ethanol or tetrahydrofuran. In some embodiments, the polymerization medium is free of organic solvents and includes only water.

The emulsion polymerization can be carried out as a batch process, as a semi-batch process, or in the form of a continuous process. In some embodiments, a portion of the monomers can be heated to the polymerization temperature and partially polymerized, and the remainder of the monomer batch can be subsequently fed to the polymerization zone continuously, in steps, or with superposition of a concentration gradient. In some embodiments, the method of making a multilayer particle comprises
(i) polymerizing a soft ethylenically unsaturated monomer, one or more phosphorus-containing monomers, an acetoacetoxy or keto monomer and additional ethylenically unsaturated monomers in a first emulsion polymerization step to produce a first copolymer having a first theoretical Tg; and
(ii) polymerizing one or more hard ethylenically unsaturated monomers, one or more acid group containing monomers, an acetoacetoxy or keto monomer and additional ethylenically unsaturated monomers in a second emulsion polymerization step to produce a second copolymer having a second theoretical Tg.
(iii) Then adding polyfunctional amines that crosslink with acetoacetate or keto monomers in first and second copolymer.

In some embodiments, the first polymerization step and/or the second copolymerization step are carried out at a first polymerization temperature ranging from 10° C. to 130° C. (e.g., from 50° C. to 100° C., or from 70° C. to 90° C.). In one embodiment, the first polymerization step and the second copolymerization step are carried out at polymerization temperatures of less than or equal to 95° C.

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be 0.1% to 30%, 0.5% to 20%, or 1.0% to 10%, by weight, based on the solution. The amount of the initiators is generally 0.1% to 2% or 0.5% to 1% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethyl esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

Dispersants, such as surfactants, can also be added during polymerization to help maintain the dispersion of the monomers in the aqueous medium. For example, the polymerization can include less than 3% by weight or less than 1% by weight of surfactants. In some embodiments, the polymerization is substantially free of surfactants and can include less than 0.05% or less than 0.01% by weight of one or more surfactants. In other embodiments, the first emulsion polymerization step and/or the second copolymerization step further comprise an aryl phosphate surfactant. (e.g., a tristyrylphenol alkoxylated phosphate surfactant (TSPAP) of the structure given below).

Anionic and nonionic surfactants can be used during polymerization. Suitable surfactants include ethoxylated C8 to C36 or C12 to C18 fatty alcohols having a degree of ethoxylation of 3 to 50 or of 4 to 30, ethoxylated mono-, di-, and tri-C4 to C12 or C4 to C9 alkylphenols having a degree of ethoxylation of 3 to 50, alkali metal salts of dialkyl esters of sulfosuccinic acid, alkali metal salts and ammonium salts of C8 to C12 alkyl sulfates, alkali metal salts and ammonium salts of C12 to C18 alkylsulfonic acids, and alkali metal salts and ammonium salts of C9 to C18 alkylarylsulfonic acids.

By way of non-limiting illustration, examples of certain embodiments of the present disclosure are given below.

### Examples

The following examples are for the purpose of illustration of the invention only and are not intended to limit the scope of the present invention in any manner whatsoever.

### Stain Resistance Testing

The Stain resistance testing of coating formulations was carried out according to a modified ASTM D 4828-94 (2012). ASTM D 4828-94(2012) is entitled “Standard Test Methods for Practical Washability of Organic Coatings,” and is incorporated herein by reference in its entirety. The test measured the degree of removal of stains applied to a dried coating. A 7 mil film of flat white base formulation was applied to a Leneta Black Scrub Panel. After 7 days of curing at 25° C. and 50% relative humidity, a series of “stains” (mustard, coffee, wine, balsamic vinegar, pencil, crayon, marker, ballpoint pen, lipstick, Lenetta ST-1) were applied on top of the painted panel. After 1 hour, excess stain material was gently washed off and blotted dry. Panels were then scrubbed for 15 cycles with a sponge and 10 cc of Leneta SC-1 (Standardized Scrub Medium Non-Abrasive type). Once dried, samples were rated for stain removal as described in ASTM D 4828-94 (2012) but with a modification to the scale were intermediate numbers were included to differentiate the degree of stain removal among samples. Example data is included in Table 3 below.

### Procedure 1: Synthesis of Polymer Dispersions

A polymerization vessel equipped with metering devices and temperature regulation was charged under a nitrogen atmosphere at 20° to 25° C. (room temperature) with initial charge. This initial charge was heated to 85° C. with stirring. When set temperature was reached, 7% of Feed 1 was added and the mixture was stirred for 5 minutes. Thereafter feeds 1 and 2 were commenced; feed 1 was metered in over 3.2 hours, and feed 2 over 2.00 hours. Ten minutes after the end of feed 2, feed 3 was added over 60 minutes. Then the monomer vessel was flushed with feed 4 water. Ten minutes after the end of feeds, temperature was reduced to 80° C. and feed 5 was added over 0.25 hours. Five minutes after the end of feed 5, feed 6 was added followed by feeds 7 and 8 were metered in over 60 minutes in parallel. After 30 minutes from the end of these feeds, the batch was cooled below 40° C. Then feed 9 was added over 5 minutes and there after feed 10 was added over 20 minutes. The batch was mixed for 5 minutes and pH adjusted to 8.5 using 19% aqueous ammonium hydroxide and filtered. % Weight solids, pH and particle size of diluted polymer dispersion were measured.

Representative examples of polymer dispersions prepared using procedure 1 are provided in Table 1.

TABLE 1
Polymer Dispersions Prepared Using Procedure
1 - Example 1-6 and comparative Example 1.

| | | Example 1 | Example 2 | Example 3 |
|---|---|---|---|---|
| | Ingredients | (grams) | (grams) | (grams) |
| Initial | Water | 455.3 | 454.1 | 461.3 |
| Charge | PolyStyrene seed | 32.8 | 32.8 | 33.2 |
| | (32% in water) | | | |
| Feed 1 | Water | 29.5 | 29.4 | 29.8 |
| | Sodium Persulfate | 3.8 | 3.8 | 3.8 |
| Feed 2 | Water | 162.1 | 161.7 | 192.2 |
| | TSPAP surfactant* | 43.4 | 43.3 | 58.5 |
| | Hydropalat WE 3320 | 1 | 1 | 1.1 |
| | Itaconic acid | 0 | 0 | 0 |
| | Sipomer PAM 4000 | 8 | 8 | 8 |
| | n-Butyl acrylate | 379.2 | 378.3 | 419.8 |
| | Methyl methacrylate | 276.7 | 276 | 435.5 |
| | Acetoacetylethyl | 0 | 0 | 0 |
| | methacrylate | | | |
| | Ureido | 47.8 | 47.6 | 0 |
| | methacrylate** | | | |
| | 19% Aqueous | 6 | 6 | 7.6 |
| | ammonium hydroxide | | | |
| Feed 3 | Water | 58.3 | 58.2 | 20.9 |
| | TSPAP surfactant* | 23.9 | 18 | 11 |
| | Methacrylic acid | 23.9 | 23.8 | 11.6 |
| | n-Butyl acrylate | 59.7 | 59.5 | 4.8 |
| | Methyl methacrylate | 61.3 | 51.6 | 78.3 |
| | Styrene | 70.2 | 69.8 | 0 |
| | Acetoacetylethyl | 28.7 | 38.1 | 9.7 |
| | methacrylate | | | |
| Feed 4 | Water | 28.7 | 28.7 | 29 |
| Feed 5 | Water | 50.3 | 50.3 | 64.6 |
| | 19% aqueous | 9.1 | 9.1 | 4.3 |
| | ammonium hydroxide | | | |
| Feed 6 | Rhodaline 635 | 1 | 1 | 1 |
| Feed 7 | Water | 32.8 | 32.8 | 34.2 |
| | Aqueous t-butyl | 3.6 | 3.6 | 1.9 |
| | hydroperoxide (70%) | | | |
| Feed 8 | Water | 32.6 | 32.6 | 33.8 |
| | D-isoascorbic acid | 4.2 | 4.2 | 2.2 |
| Feed 9 | Water | 15 | 15 | 28.2 |
| | 19% aqueous | 5 | 5 | 1 |
| | ammonium hydroxide | | | |
| Feed | Water | 47.8 | 47.7 | 48.3 |
| 10 | Baxxodur EC 310 | 15.8 | 21 | 5.3 |

| | | | |
|---|---|---|---|
| % Weight solids | 50.6 | 49.7 | 50.9 |
| pH | 8.5 | 8.5 | 8.5 |
| Particle size | 130 | 126 | 128 |
| (volume average, nm) | | | |

| | | | | | Compar- |
|---|---|---|---|---|---|
| | | Exam- | Exam- | Exam- | ative exam- |
| | | ple 4 | ple 5 | ple 6 | ple 1 |
| | Ingredients | (grams) | (grams) | (grams) | (grams) |
| Initial | Water | 456.5 | 490.3 | 456.5 | 445.1 |
| Charge | PolyStyrene seed | 32.9 | 33.2 | 32.9 | 32.78 |
| | (32% in water) | | | | |
| Feed 1 | Water | 29.5 | 29.8 | 29.5 | 82.5 |
| | Sodium | 3.8 | 3.8 | 3.8 | 10.7 |
| | Persulfate | | | | |
| Feed 2 | Water | 164 | 179 | 164 | 219.3 |
| | TSPAP | 43.5 | 52.7 | 43.5 | 52.1 |
| | surfactant* | | | | |
| | Hydropalat WE | 1.1 | 1.1 | 1.1 | 1.1 |
| | 3320 | | | | |
| | Itaconic acid | 0 | 0 | 0 | 6.7 |
| | Sipomer PAM | 8 | 8.9 | 8 | 5.7 |
| | 4000 | | | | |
| | n-Butyl acrylate | 380.3 | 382.8 | 380.3 | 434 |
| | Methyl | 263.1 | 401.3 | 270.4 | 400.5 |
| | methacrylate | | | | |
| | Acetoacetylethyl | 14.4 | 0 | 0 | 38.2 |
| | methacrylate | | | | |
| | Diacetone | 0 | 0 | 7.7 | 0 |
| | acrylamide | | | | |
| | Ureido | 47.9 | 0 | 48.0 | 0 |
| | methacrylate** | | | | |
| | 19% Aqueous | 4.2 | 4.7 | 4.2 | 8.3 |
| | ammonium | | | | |
| | hydroxide | | | | |
| Feed 3 | Water | 58.5 | 41.3 | 58.5 | 65.5 |
| | TSPAP | 18.1 | 12.8 | 18.1 | 10.8 |
| | surfactant* | | | | |
| | Methacrylic acid | 23.9 | 9.7 | 23.9 | 0 |
| | n-Butyl acrylate | 59.9 | 29 | 59.9 | 0 |
| | Acetoacetylethyl | 4.8 | 7.7 | 0 | 0 |
| | methacrylate | | | | |
| | Diacetone | 0 | 0 | 4.8 | 0 |
| | acrylamide | | | | |
| | Methyl | 85.4 | 127.7 | 85.4 | 68.8 |
| | methacrylate | | | | |
| | Styrene | 70.2 | 0 | 70.2 | 0 |
| Feed 4 | Water | 28.7 | 29 | 28.7 | 28.6 |
| Feed 5 | Water | 50.3 | 60.9 | 50.3 | 62.8 |
| | 19% aqueous | 9.1 | 8.6 | 9.1 | 5.7 |
| | ammonium | | | | |
| | hydroxide | | | | |
| Feed 6 | Rhodaline 635 | 1 | 1 | 1 | 1 |
| Feed 7 | Water | 32.8 | 34.2 | 32.8 | 42.3 |
| | Aqueous t-butyl | 3.6 | 1.9 | 3.6 | 2.5 |
| | hydroperoxide | | | | |
| | (70%) | | | | |
| Feed 8 | Water | 32.6 | 33.9 | 32.6 | 42.2 |
| | Sodium | 0 | 2.2 | 0 | 2.6 |
| | metabisulfite | | | | |
| | D-iso ascorbic | 4.2 | 0 | 4.2 | 0 |
| | acid | | | | |
| Feed 9 | Water | 15.1 | 0 | 15.1 | 20.5 |
| | 19% aqueous | 5 | 0 | 5 | 10 |
| | ammonium | | | | |
| | hydroxide | | | | |
| Feed 10 | Water | 47.9 | 48.5 | 48 | 0 |
| | Baxxodur EC | 10.7 | 4.2 | 0 | 0 |
| | 310 | | | | |
| | Adipic | 0 | 0 | 5.8 | 0 |
| | dihydrazide | | | | |

| | | | | |
|---|---|---|---|---|
| % Weight solids | 49.8 | 50.3 | 49.5 | 49.4 |
| pH | 8.5 | 8.5 | 8.4 | 8.5 |
| Particle size | 129 | 122 | 138 | 140 |
| (volume average, nm) | | | | |

*Tristyrylphenol alkoxylated phosphate surfactant
**25% Ureido methacrylate in methylmethacrylate

Representative paint formulations for the polymer dispersions of examples 1-6 and comparative example 1 are provided in Table 2:

| Raw materials | Grams |
|---|---|
| Water | 100.0 |
| Natrosol ™ Plus 250H4BR | 0.5 |
| AMP-95 ™ | 1.0 |
| TAMOL ™ 165A | 12.3 |
| FoamStar ® ST 2412 | 2.0 |
| Proxel ™ BD | 4.0 |
| Kronos ® 2310 | 172.7 |
| Minex 3 ® | 122.5 |
| ASP ® NC X1 | 25.0 |
| Attagel ®50 | 2.0 |

Grind above for raw materials for 20 minutes
and let down with the following raw materials

| | |
|---|---|
| Polymer dispersion of examples 1 to 5 | 420* |
| Water | 30.0 |
| FoamStar ® ST 2412 | 2.0 |
| Velate ™ 368 | 14.0 |
| Aquaflow ™ NHS-310 | 16.0 |
| Rheovis ® PU1251 | 1.3 |
| Water | 159.3 |
| Total Weight | 664.6 |

*50% solids polymer dispersion; adjusted based on actual % solids to get 210 grams of solid polymer

TABLE 3
Stain Resistance evaluation of Examples 1-6 and comparative Example

| | Comparative | Example | Example | Example | Example | Example | Example |
|---|---|---|---|---|---|---|---|
| | Example | 1 | 2 | 3 | 4 | 5 | 6 |
| Pencil | 3 | 8 | 9 | 9 | 8 | 5 | 5 |
| Purple Crayon | 3 | 5 | 3 | 3 | 2 | 3 | 1 |
| Black Ballpoint Pen | 0 | 1 | 0 | 1 | 1 | 0 | 1 |
| Lipstick | 5 | 7 | 8 | 7 | 8 | 9 | 9 |
| Mustard | 2 | 5 | 5 | 6 | 6 | 4 | 4 |
| Red Wine | 7 | 8 | 7 | 8 | 6 | 8 | 7 |
| Hot Coffee | 2 | 4 | 5 | 4 | 4 | 4 | 5 |
| Balsamic Vinegar | 7 | 7 | 8 | 7 | 7 | 8 | 7 |
| Leneta ST1 | 3 | 5 | 4 | 4 | 4 | 6 | 7 |
| Total | 32 | 50 | 49 | 49 | 46 | 47 | 46 |

Samples were rated for stain removal as described in ASTM D 4828-94 (2012) but with a modification to the scale were intermediate numbers were included to differentiate the degree of stain removal among samples. The stain removal is rated as follows: 0—No change from original intensity (depth) of stain, 3-slight change from original but readily visible. 5-Moderate change from original slightly visible, 7-Large change from original, barely visible, and 10—All stains removed. The total rating for each sample, which is a sum of the ratings for different stains, is listed at the bottom. The higher the total rating the easier is the stain removal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

Preferred embodiments of this invention are described herein, including the best mode known to the inventors for carrying out the invention. It should be understood that the illustrated embodiments are exemplary only, and should not be taken as limiting the scope of the invention.

1.-33. (canceled)

34. A multilayer particle comprising
(i) a first layer comprising a first copolymer derived from a soft ethylenically-unsaturated monomer, a phosphorus-containing monomer, and optionally an acetoacetoxy or keto monomer and a polyfunctional amine; and
(ii) a second layer surrounding at least a portion of the first layer comprising a second copolymer derived from one or more hard ethylenically-unsaturated monomers, at least one ethylenically unsaturated acid monomer; and optionally an acetoacetoxy or keto monomer and a polyfunctional amine.

35. The multilayer particle of claim 34, wherein the first copolymer exhibits a Tg, as measured by differential scanning calorimetry (DSC) using the mid-point temperature as described in ASTM D3418-15, from −100° C. to 50° C.

36. The multilayer particle of claim 34, wherein the second copolymer exhibits a Tg, as measured by differential scanning calorimetry (DSC) using the mid-point temperature as described in ASTM D3418-15, from 5° C. to 250° C.

37. The multilayer particle of claim 34, wherein the first copolymer is derived from
(i) greater than 20% by weight of total first layer monomer one or more soft (meth)acrylate monomers;
(ii) greater than 0% by weight to 10% by weight of total first layer monomers of one or more phosphorus acid-containing monomers;
(iii) greater than 0% by weight to 15% by weight of total first layer monomers of one or more acetoacetoxy monomers or keto monomers and a polyfunctional amine; and
(iv) optionally one or more additional ethylenically-unsaturated monomers, excluding monomers (i), (ii), and (iii).

38. The multilayer particle of claim 34, wherein the second copolymer is derived from
(i) greater than 30% by weight of total second layer monomer one or more hard (meth)acrylate monomers;
(ii) greater than 0% by weight to 30% by weight of total second layer monomers one or more acid-containing monomer.
(iii) greater than 0% by weight to 15% by weight of total second layer monomers of one or more acetoacetoxy monomers or keto monomers and a polyfunctional amine; and
(iv) optionally one or more additional ethylenically-unsaturated monomers, excluding monomers (i), (ii), and (iii).

39. The multilayer particle of claim 34, wherein the first copolymer comprises styrene, methyl (meth)acrylate, n-butyl(meth)acrylate, t-butyl(meth)acrylate, i-butyl(meth)acrylate, cyclohexyl(meth)acrylate, 2-ethylhexyl (meth)acrylate or a combinations thereof.

40. The multilayer particle of claim 34, wherein the second copolymer is derived from at least 55% by weight of total second layer monomer of monomers selected from the group consisting of methyl (meth)acrylate, styrene, n-butyl methacrylate, t-butyl (meth)acrylate, i-butyl methacrylate, cyclohexyl (meth)acrylate, and combinations thereof, based on the total weight of monomers used to form the second copolymer.

41. The multilayer particle of claim 34, wherein the at least one ethylenically unsaturated acid monomer is selected from the group consisting of carboxylic acid-monomer, dicarboxylic acid monomer, sulfur acid-monomer, phosphorous acid-monomer, and combinations thereof.

42. The multilayer particle of claim 43, wherein the carboxylic acid-containing monomers are selected from the group consisting of acrylic acid, methacrylic acid, itaconic acid, maleic acid, fumaric acid, and combinations thereof.

43. The multilayer particle of claim 34, wherein the phosphorus-containing monomers are selected from the group consisting of 2-phosphoethyl (meth)acrylate, 2-phosphopropyl (meth)acrylate, 3-phosphopropyl (meth)acrylate, phosphobutyl (meth)acrylate, 3-phospho-2-hydroxypropyl (meth)acrylate, vinylphosphonic acid, methyl vinylphosphonic acid, alkyl or ethyl methacrylate phosphate, phosphate esters of polypropylene glycol mono (meth)acrylate, phosphate esters of polyethylene glycol mono (meth)acrylate, phosphate esters of mixture of polypropylene glycol mono (meth)acrylate and polyethylene glycol mono (meth)acrylate, and mixtures thereof.

44. The multilayer particle of claim 34, wherein the acetoacetoxy or keto monomers are selected from the group consisting of acetoacetoxyethyl (meth)acrylate (AAEM), acetoacetoxypropyl (meth)acrylate, acetoacetoxybutyl (meth)acrylate, 2,3-di(acetoacetoxy)propyl (meth)acrylate, allyl acetoacetate, vinyl acetoacetate, diacetone acrylamide and combinations thereof.

45. The multilayer particle of claim 34, wherein the polyfunctional amine comprises a polyamine, polyetheramine or polyhydrazide.

46. The multilayer particle of claim 34, wherein the polyfunctional amine is present at acetoacetate or keto to primary amine group equivalent ratio of 1:0.4 to 1:1.2, and wherein the weight ratio of the first copolymer to the second copolymer is in a range of from 40:60 to 95:5

47. The multilayer particle of claim 34, wherein the second copolymer comprises at least one ethylenically unsaturated acid in an amount from 2% to 30%, by weight based on the total monomer weight in the second copolymer.

48. A multilayer particle comprising
(i) a first layer comprising a first copolymer derived from a soft ethylenically-unsaturated monomer, a phosphorus-containing monomer, and an acetoacetoxy or keto monomer and a polyfunctional amine; and
(ii) a second layer surrounding at least a portion of the first layer comprising a second copolymer derived from one or more hard ethylenically-unsaturated monomers, at least one ethylenically unsaturated acid monomer; and an acetoacetoxy or keto monomer and a polyfunctional amine.

49. An aqueous composition comprising a plurality of multilayer particles defined by claim 34 dispersed in an aqueous medium.

50. The composition of claim 49, wherein the aqueous composition further comprises an aryl phosphate surfactant.

51. The composition of claim 50, wherein the aryl phosphate surfactant comprises a tristyrylphenol alkoxylated phosphate.

52. A coating comprising a plurality of multilayer particles defined by claim 34.

53. A method of making a multilayer particle, comprising
(i) polymerizing a soft ethylenically-unsaturated monomer, a phosphorus-containing monomer, and optionally an acetoacetoxy or keto monomer in a first emulsion polymerization step to produce a first copolymer; and
(ii) polymerizing one or more hard ethylenically-unsaturated monomer, at least one ethylenically unsaturated acid monomer, and optionally one or more acetoacetoxy or keto monomer to produce a second copolymer; and adding polyfunctional amine.

54. The method of claim 53, wherein the one or more hard ethylenically-unsaturated monomers selected from the group consisting of methyl (meth)acrylate, styrene, n-butyl methacrylate, t-butyl (meth)acrylate, i-butyl methacrylate, cyclohexyl (meth)acrylate, and combinations thereof.

55. The method of claim 54, wherein the emulsion polymerization further comprises an aryl phosphate surfactant.

56. The method of claim 55, wherein the aryl phosphate surfactant comprises a tristyrylphenol alkoxylated phosphate surfactant.
